(19) United States
(12) Patent Application Publication
(10) Pub. No.: US 2012/0180907 A1
(43) Pub. Date: Jul. 19, 2012

(54) Level Adjusting Device for Worktable of Jointer/Planer Machine

(76) Inventor: James Liu, Taichung City (TW)

(21) Appl. No.: 13/007,734

(22) Filed: Jan. 17, 2011

(51) Int. Cl. B27C 1/14

(52) U.S. Cl. 144/129

(57) ABSTRACT

A woodworking machine includes a base, an adjusting device, and an adjustable worktable. The adjusting device is engaged with the base and includes a platform, a plurality of adjusters, and a plurality of fastening members. The platform is slidably engaged with the base. The plurality of adjusters are adjustable, and the plurality of fastening members are releasably inserted through the plurality of adjustors respectively. The adjustable worktable is engaged with the adjusting device. Moreover, the platform bears the adjustable worktable and the plurality of adjusters are abutted against the adjustable worktable. Additionally, the adjustable worktable is adjustably moved upon adjusting of the adjustors, and prior to adjusting each adjustor, the fastening member engaged therewith is removed.

### BACKGROUND OF THE INVENTION

1. Field of the Invention

The present invention relates to an adjusting device and, in particular, to an adjusting device used for a level adjustment of worktable(s) of a jointer/planar machine.

2. Description of the Related Art

U.S. Pat. No. 7,721,458 discloses the teaching as to a level adjusting device for a cutter of a jointer/planar machine of the applicant of the instant application. According to the disclosure, the level adjusting device includes a front support frame having a front seat wall for supporting a front anti-friction bearing unit that holds a front journal segment of a cutter head, and a rear support frame spaced apart from the front support frame. The rear support frame includes left and right base abutments facing upwardly. A height-adjustable carrier has an insertion bore for receiving a rear anti-friction bearing member that holds a rear journal segment of the cutter head. Left and right lugs are disposed outboard of the height-adjustable carrier, and respectively have inner tubular threaded surfaces. Left and right adjusting screws respectively have threaded segments that are engaged threadly and respectively with the inner tubular threaded surfaces of the lugs, and abutting ends configured to be in frictional engagement with the base abutments, respectively. The abutting end of each adjusting screw is turnable about a revolving axis in the upright direction such that the respective lug is moved relative to the adjusting screw so as to raise or lower the carrier, thereby enabling a level adjustment of the cutter head.

Furthermore, China Pat. No. 200995413 shows a planar including a base, and a cutting mechanism disposed on the center of the top of the base. The cutting mechanism includes worktables disposed aside. The worktables include a first worktable that is integrally formed with the base, and a second worktable that is moveable. Further, a slide is disposed between the base and the second worktable and includes a lifting mechanism disposed thereon. Further, two pairs of adjusting screws are symmetrically disposed on the slide, and a pressing member is disposed on each pair of the adjusting screws. Additionally, the second worktable includes two elongated members disposed on the bottom thereof and abutting against the two pressing members, respectively. Moreover, the second worktable is to be adjusted to be level with the first worktable such that the first and second worktables cooperate to form a level surface, and in addition, by adjusting the adjusting screws the pressing members are adapted to be moved which results in the movement of the second worktable.

However, it is still desirable to utilize a level adjusting device for an accurate level adjustment of worktable(s).

The present invention is, therefore, intended to obviate or at least alleviate the problems encountered in the prior art.

### SUMMARY OF THE INVENTION

According to the present invention, a woodworking machine includes a base, an adjusting device, and an adjustable worktable. The adjusting device is engaged with the base and includes a platform, a plurality of adjusters, and a plurality of fastening members. The platform is slidably engaged with the base. The plurality of adjusters are adjustable, and the plurality of fastening members are releasably inserted through the plurality of adjustors respectively. The adjustable worktable is engaged with the adjusting device and includes a plurality of receptacles defined therein and a plurality of retaining structures disposed therein. Moreover, the platform bears the adjustable worktable and the plurality of adjusters are abutted against the adjustable worktable. Additionally, the adjustable worktable is adjustably moved upon adjusting of the adjustors, and prior to adjusting each adjustor, the fastening member engaged therewith is removed.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a level adjusting device and worktables in accordance with a first embodiment of the present invention.

FIG. 2 is an exploded perspective view of the level adjusting device and the worktables of FIG. 1.

FIG. 3 is another perspective view of the level adjusting device and the worktables of FIG. 1 taken from a different angle of view than that of FIG. 2.

FIG. 4 is a cross-sectional view of the level adjusting device of FIG. 1.

FIG. 5 is a partial, enlarged view of FIG. 4.

FIG. 6 is another partial, enlarged view of FIG. 4.

FIG. 7 is a continued cross-sectional view of FIG. 6 and shows the worktable that is to be adjusted undergoing a level adjustment operation and a tool for carrying out the adjustment, with the tool shown in phantom.

FIG. 8 is a continued cross-sectional view of FIG. 7 and shows the worktable adjusted to another horizontal position different than that of FIG. 6.

FIG. 9 is a perspective view of a level adjusting device and worktables in accordance with a second embodiment of the present invention.

FIG. 10 is an exploded perspective view of the level adjusting device and the worktables of FIG. 9.

FIG. 11 is another perspective view of the level adjusting device and the worktables of FIG. 9 taken from a different angle of view than that of FIG. 10.

FIG. 12 is a cross-sectional view of the level adjusting device and the worktables of FIG. 9.

FIG. 13 is a partial, enlarged view of FIG. 12.

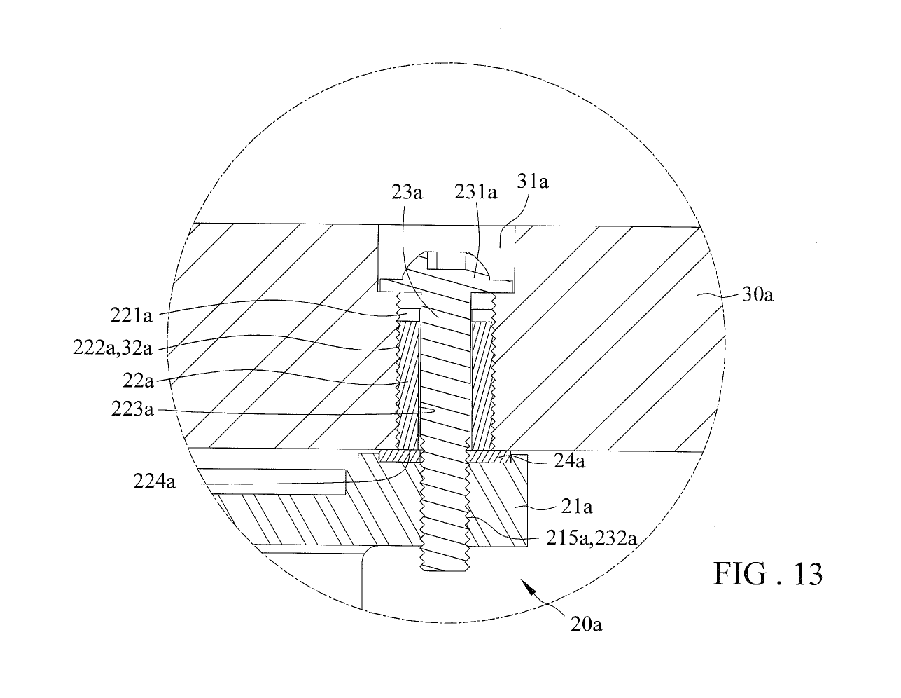

FIG. 14 is a continued cross-sectional view of FIG. 13 and shows the worktable that is to be adjusted undergoing a level adjustment operation and a tool for carrying out the adjustment, with the tool shown in phantom.

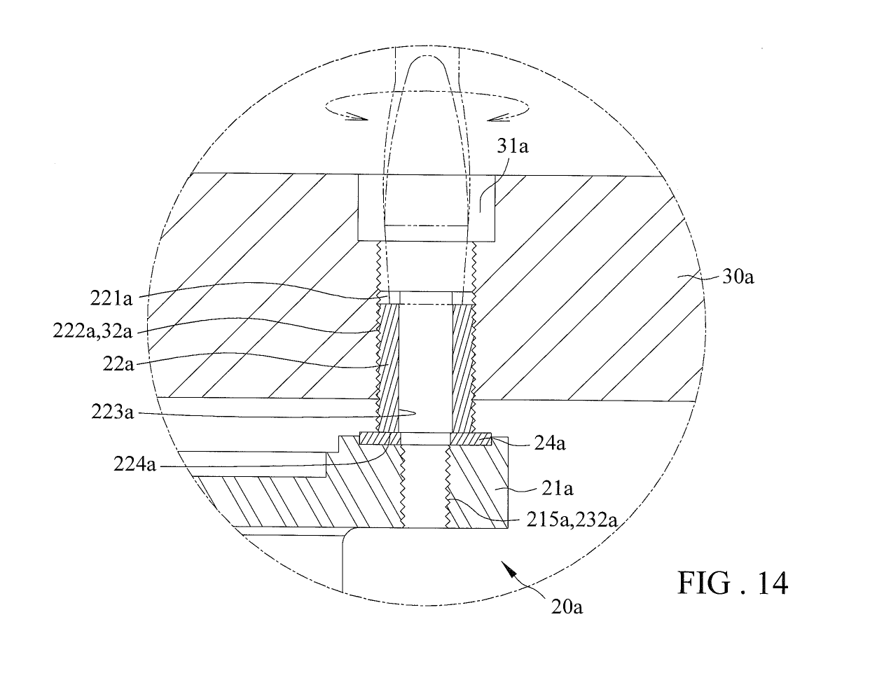

FIG. 15 is a continued cross-sectional view of FIG. 14 and shows the worktable adjusted to another horizontal position different than that of FIG. 13.

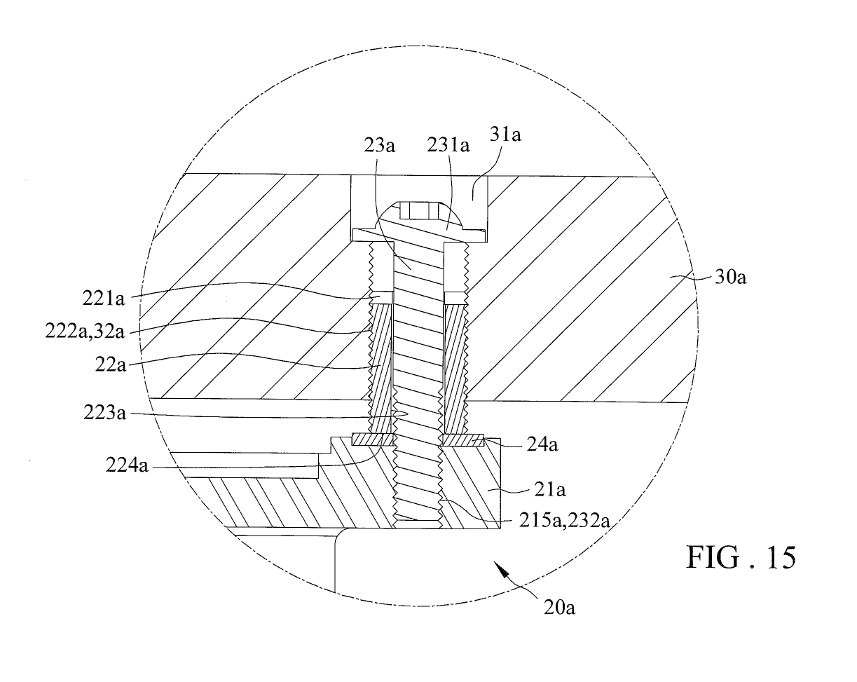

FIG. 16 is a perspective view of a level adjusting device and worktables in accordance with a third embodiment of the present invention.

FIG. 17 is an exploded perspective view of the level adjusting device and the worktables of FIG. 16.

FIG. 18 is a cross-sectional view showing the worktable that is to be adjusted in a horizontal position.

FIG. 19 is a continued cross-sectional view of FIG. 18 and shows the worktable undergoing a level adjustment operation and a tool for carrying out the adjustment, with the tool shown in phantom.

FIG. 20 is a continued cross-sectional view of FIG. 18 and shows the worktable adjusted to another horizontal position different than that of FIG. 18.

### DETAILED DESCRIPTION OF THE PREFERRED EMBODIMENTS

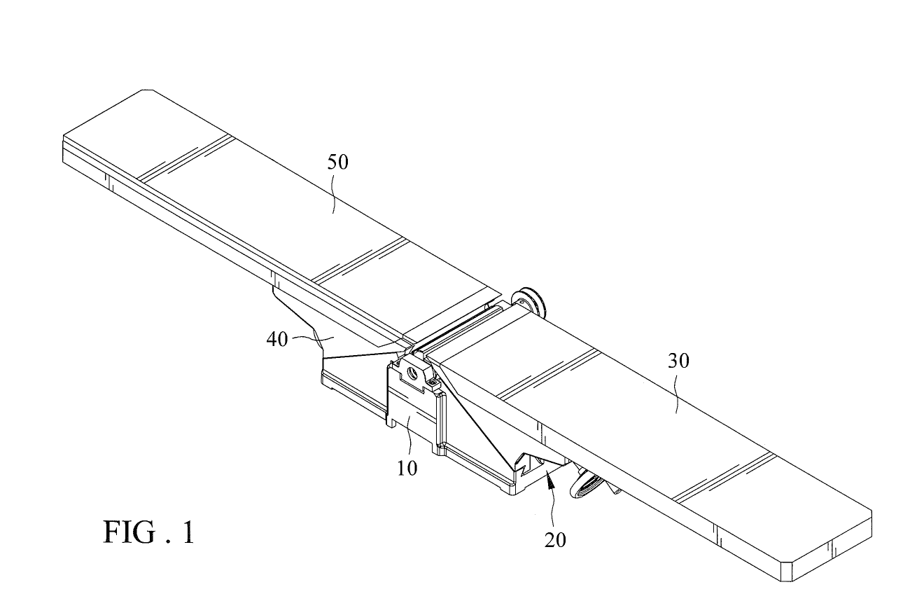

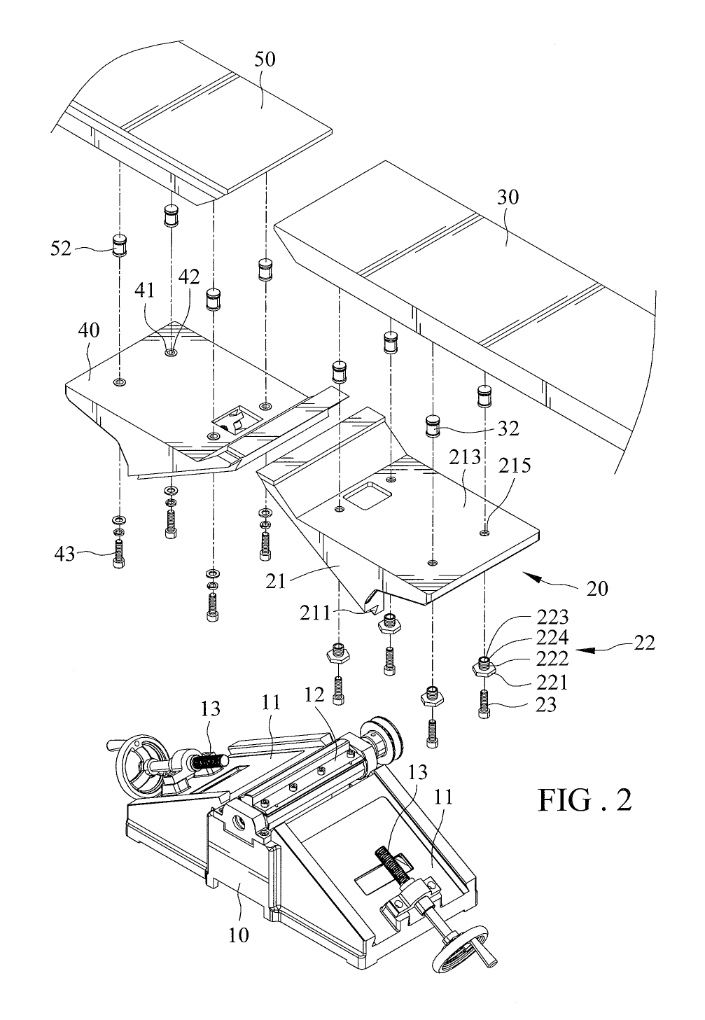

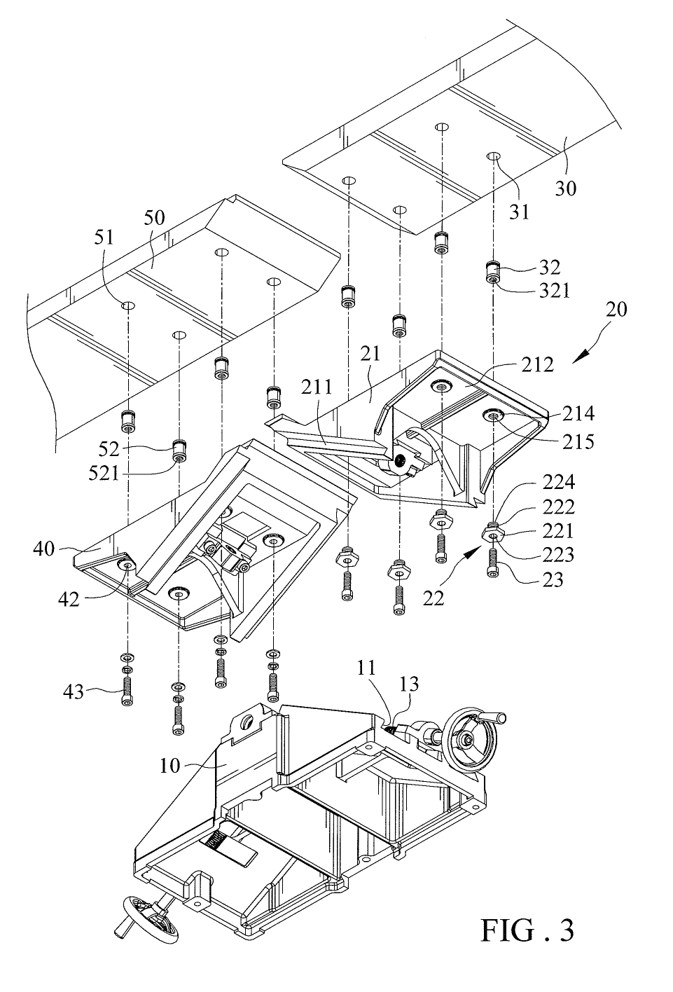

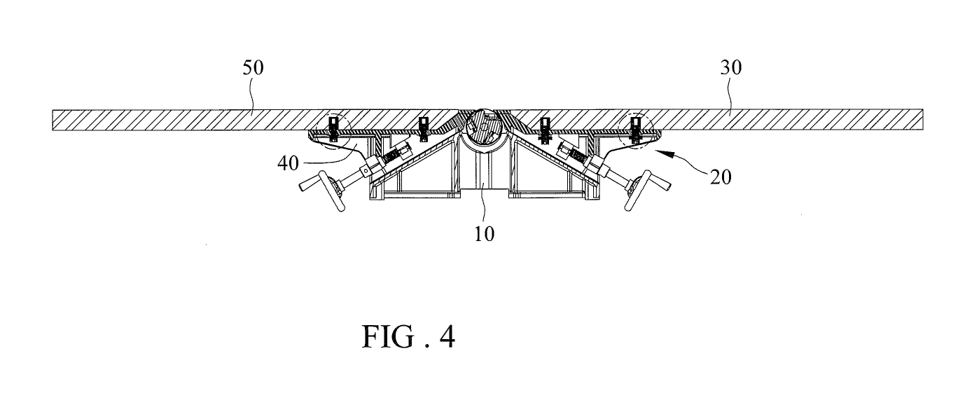

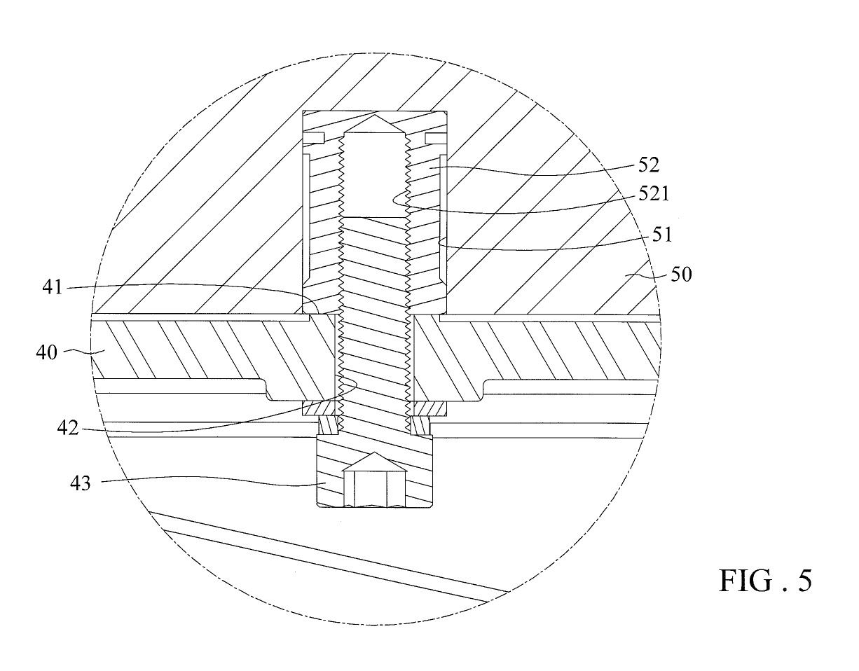

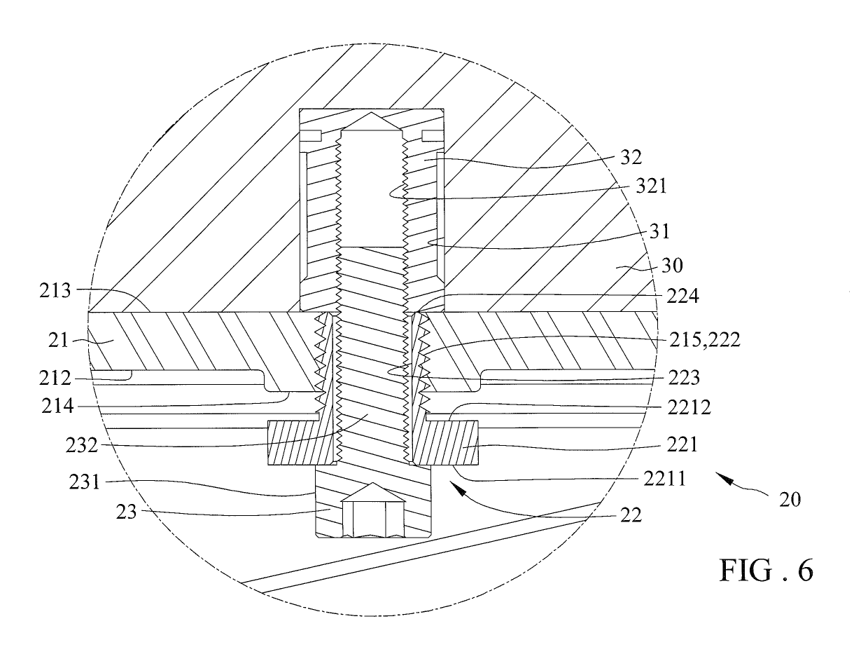

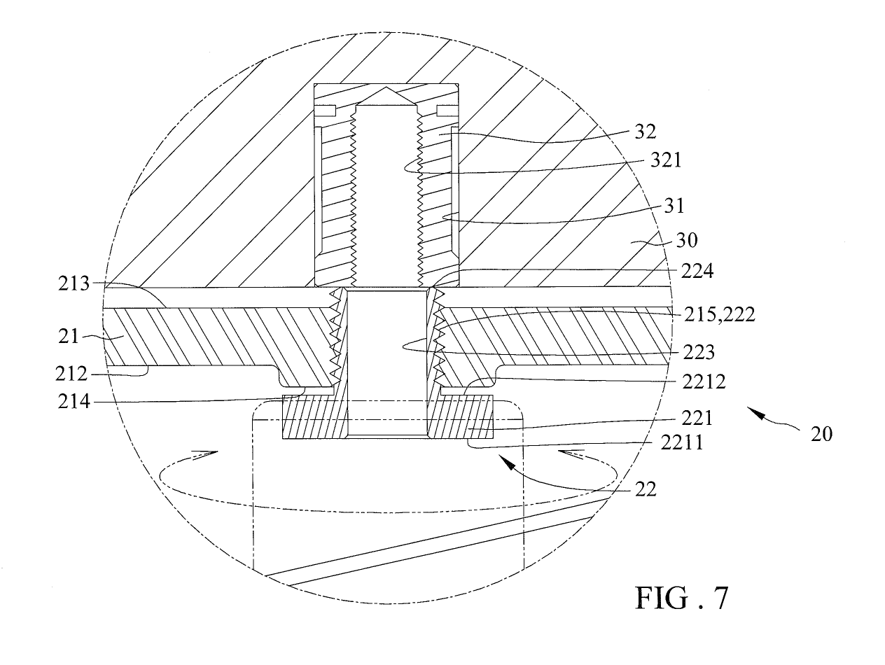

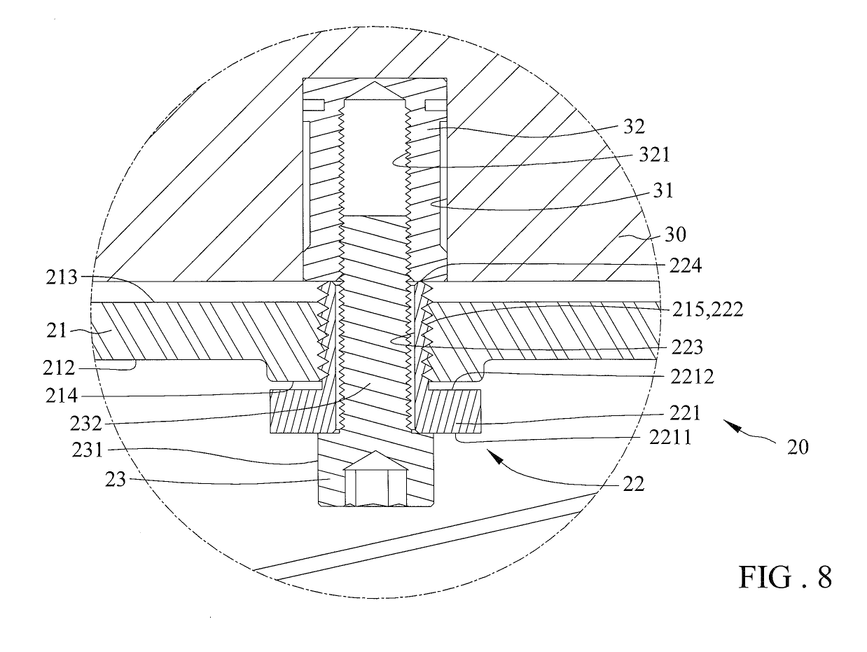

FIGS. 1 through 8 show a level adjusting device and worktables in accordance with a first embodiment of the present invention include a base 10, an adjusting device 20, two worktables including an adjustable worktable 30 and a fixed worktable 50, and a fixing device 40.

The base 10 includes two symmetrically disposed slides 11, which form a dovetail channel individually. The base 10 further includes a cutter-mounting body 12 receiving a cutter that is used to plane a workpiece. The cutting-mounting body 12 is interposed between the two slides 11 and is adapted to be adjusted up and down, thereby allowing the cutter to be adjusted up and down. Further, an adjusting mechanism 13 is disposed on each slide 11. The adjusting device 20 is disposed on one slide 11 and engages with the adjustable worktable 30, and in addition, one of two adjusting mechanisms 13 is in connection with the adjusting device 20 and is operated to urge the adjusting device 20 to move relative to the base 10 to cause the adjustable worktable 30 to move up and down. Likewise, the fixing device 40 is disposed on the other slide 11 and engages with the fixed worktable 50, and in addition, the other adjusting mechanism 13 is in connection with the fixing device 40 and is operated to urge the fixing device 40 to move relative to the base 10 to cause the fixed worktable 50 to move to a predetermined horizontal position before being rolled out. In this regard, the adjustable table 30 is adjusted with respect to a horizontal position of the fixed worktable 50 thereafter.

Furthermore, the adjustable worktable 30 and the fixed worktable 50 are made of granite. Additionally, the fixed worktable 50 includes a plurality of receptacles 51 defined in the back thereof and including a smooth inner periphery individually. Note that the inner periphery of each receptacle 51 is not threaded for the fixed worktable 50 is made of granite and it is difficult to fabricate the receptacles 51 with such complicated structures therein. Further, a plurality of retaining structures 52 are inserted in the plurality of receptacles 51, respectively, and each does not extend out of the receptacle 51 engaged therein, and in addition, each includes a hole 521 defined therein, and the hole 521 has a threaded inner periphery.

As set forth, the fixing device 40 is slidably engaged in one slide 11 of the base 10. In addition, the fixing device 40 includes a surface including a plurality of stopping structures 41 extending therefrom and a plurality of bores 42 extending therethrough and coaxially with and through the plurality of stopping structures 41, respectively. Further, a fastener 43 is inserted in and through each bore 42 and is in thread engagement with the hole 521 of each retaining structure 52, namely, the fastener 43 includes a threaded body inserted through the bore 42 and an end of the threaded body is threadly engaged with the hole 521 of the retaining structure 52. Furthermore, each stopping structure 41 is abutted against each retaining structure 52, namely, the stopping structure 41 has a first surface and the retaining structure 52 has a second surface contacting with the first surface. In this regard, the fixing device 40 and the fixed worktable 50 are in a surface contact which allows the fixing surface 40 to bear the fixed worktable 50 stably.

As also set forth, the adjusting device 20 is slidably engaged in one slide 11 of the base 10. In addition, the adjusting device 20 includes a platform 21, a plurality of adjusters 22, and a plurality of fastening members 23. The platform 21 is made of cast iron for better shock absorption and is slidably engaged with the base 10, and in addition, includes an engaging section 211 for engaging with one slide 11 of the base 10, a bottom surface 212, and a top surface 213 opposite to and parallel with the bottom surface 212. The engaging section 211 of the adjusting device 20 is in the form of a dovetail and mutually and movably fits in the slide 11 of the base 10. Further, a plurality of stopping structures 214 extend from the bottom surface 212 and a plurality of apertures 215 extending through the bottom and top surfaces 212 and 213 as well as the plurality of stopping structures 214, respectively. Also, each aperture 215 has a threaded inner periphery. The plurality of adjusters 22 are to be adjusted for urging the adjustable worktable 30. Each adjuster 22 includes a first section 221 to be engaged with a tool for facilitating an adjustment of the adjuster 22, a second section 222 to be adjustably engaged in one of the apertures 215, and a through hole 223 extending through the first and second sections 221 and 222, and in addition, the second section 222 defines a contacting end 224 at a distal end thereof. That is, a wrench is adapted to be used to adjust the relative position of each adjustor 22 in the aperture 215 engaged therewith, with the wrench clutching the first section 221. In the preferred embodiment, the first section 221 of each adjustor 22 is of a hexagonal cross section. Additionally, the second section 222 of each adjustor 22 has a threaded outer periphery in thread engagement with the inner periphery of the aperture 215 engaged therewith. Furthermore, the first section 221 of each adjustor 22 includes two opposing planar sides defining a first planar side 2211 and a second planar side 2212, and the first planar side 2211 defines a distal end of the adjustor 22, and in addition, the second planar side 2212 is an interface of the first and second sections 221 and 222. The plurality of fastening members 23 are to be inserted through the through holes 223 of the plurality of adjustors 22, respectively. Each fastening member 23 includes a first section 231, and a second section 232 extending from the first section 231, and in addition, the first section 231 includes a recess defined therein to be engaged with a tool that facilitates an adjustment of the fastening member 23, and the second section 232 includes a threaded outer periphery.

The adjustable worktable 30 is made of granite. Basically, the granite made worktable 30 has a superior ability to remain flat and to resist against any intrinsic and extrinsic deformation because granite has hardness of 5-7 according to Moh's hardness, which is 8 times higher than steel, and 2.5 times higher than cast steel, and is not susceptible to erosion caused by acid, and can sustain at least the pressure of 2000 thousand gram per square millimeter. In addition, granite is insulated from magnetic forces, and is not sticky to foreign matters, as well as is resistant to intrinsic deformation caused by temperature and humidity changes, and is able to be maintained and cleaned easily. Furthermore, the adjustable worktable 30 includes a plurality of receptacles 31 defined in the back thereof, and a plurality of retaining structures 32 inserted in the plurality of receptacles 31, respectively. Each retaining structure 32 does not extend out of the receptacle 31 engaged therein and includes a hole 321 defined therein, and the hole 321 includes a threaded inner periphery. Moreover, the adjustable worktable 30 is abutted against the top surface 213 of the platform 21, with the holes 321 of the plurality of the retaining structures 32 aligned with the plurality of apertures 215 in platform 21, respectively, with the contacting end 224 of each adjuster 22 abutted against one retaining structure 32, and with the second sections 232 of the plurality of fastening members 23 inserted through the through holes 223 of the plurality of the adjusters 22 and engaged in the holes 321 of the plurality of the retaining structures 32, respectively. Preferably, the second section 232 of each fastening member 23 is not abutted against an inner periphery of the through holes 223 of each adjuster 22. In the preferred embodiment, the first section 231 of each fastening member 23 is abutted against the first planar side 2211 of the adjustor 22 engaged therewith.

The adjusting device 20 is used to make the adjustable worktable 30 level with the fixed worktable 50. In this regard, the adjustable worktable 30 is adjusted by adjusting the adjustors 22 with respect to the apertures 215 engaged therein, and the adjustable worktable 30 is moved by the adjustors 22. Additionally, prior to adjusting each adjustor 22, the fastening member 23 engaged therewith is removed and disengaged from the retaining structure 32 engaged therewith with a tool that facilitates the removal thereof. After the fastening member 23 is removed, a tool for facilitating an adjustment of the adjustor 22 is engaged with the first section 221 and is operated to drive the adjustor 22 to urge the retaining structure 32 abutted thereagainst, i.e., the contacting end 224 of the adjustor 22 is abutted against the retaining structure 32 as set forth. In this regard, the adjustable worktable 30 is moved as the retaining structures 32 are urged. Furthermore, each fastening member 23 that has been disengaged from the adjustor 22 and the retaining structure 32 engaged therewith during a level adjustment of the adjustable worktable 30 is inserted through the adjustor 22 and retain in the retaining structure 32 engaged therewith previously after the adjustment is finished.

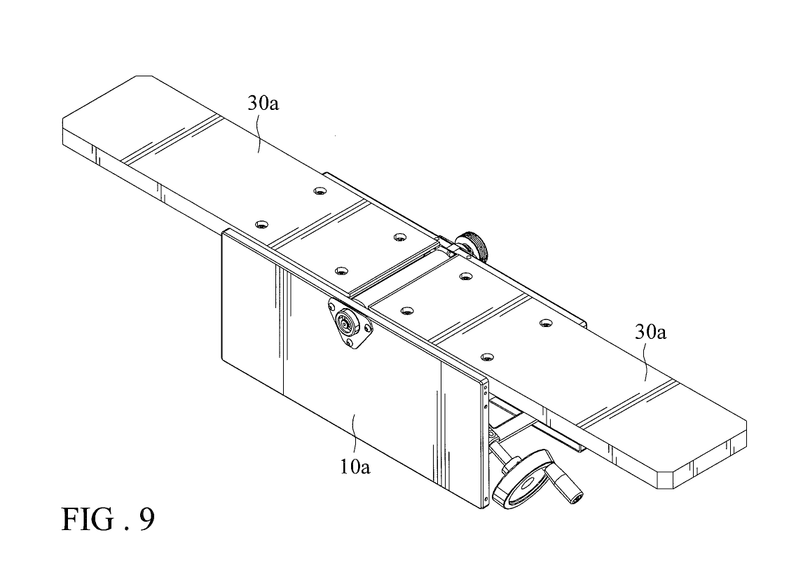

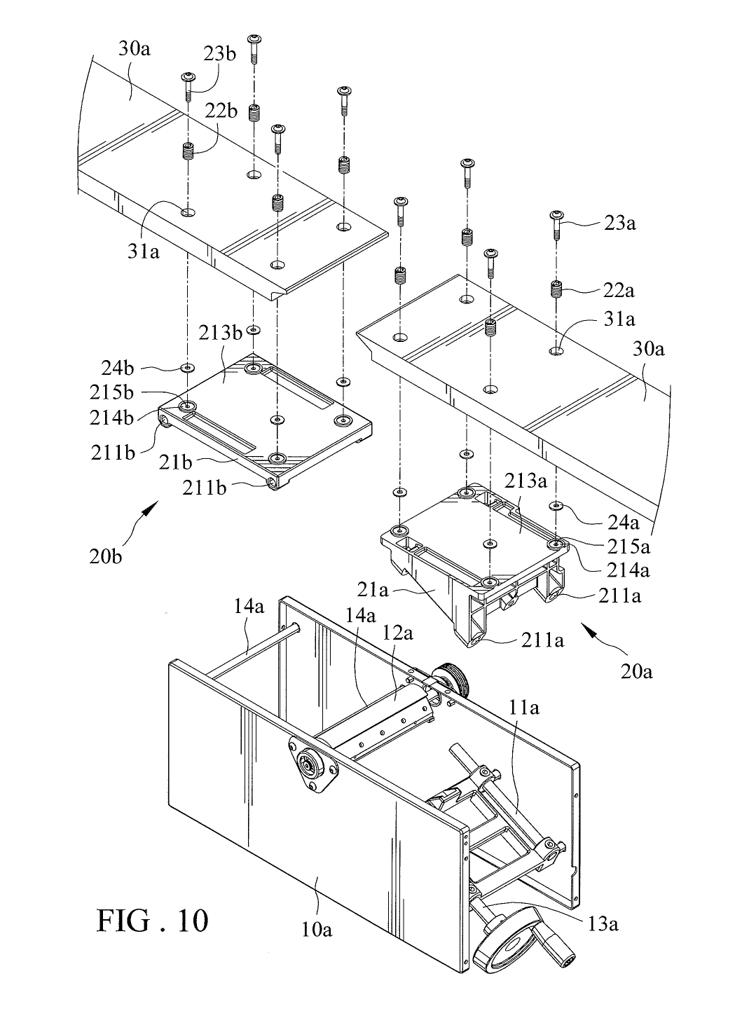

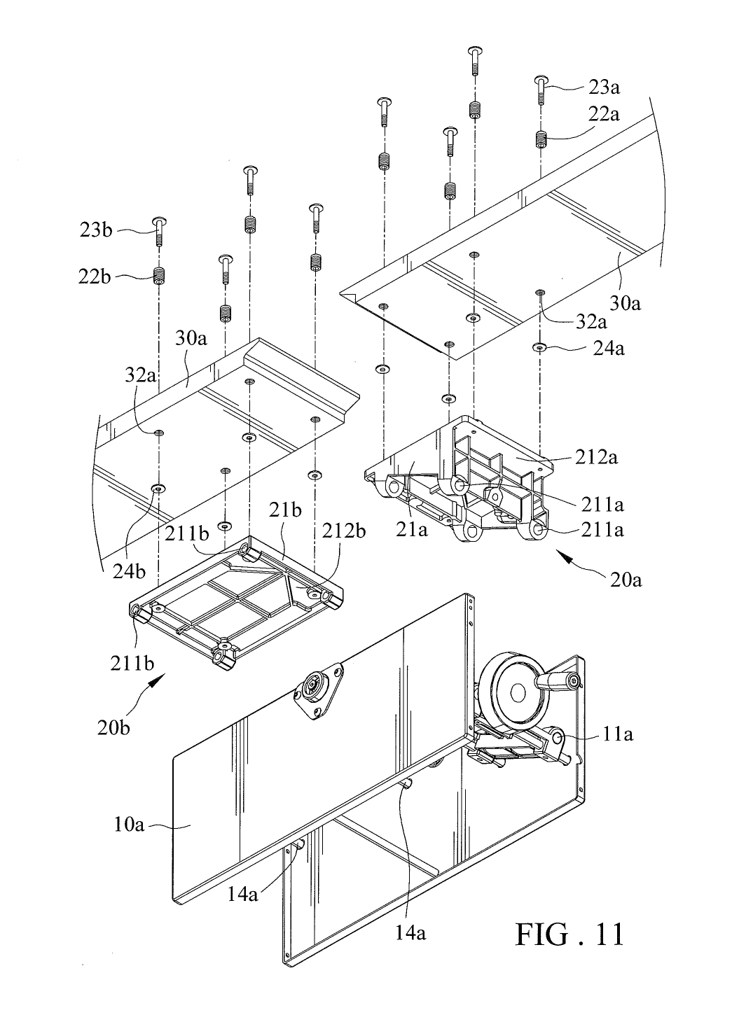

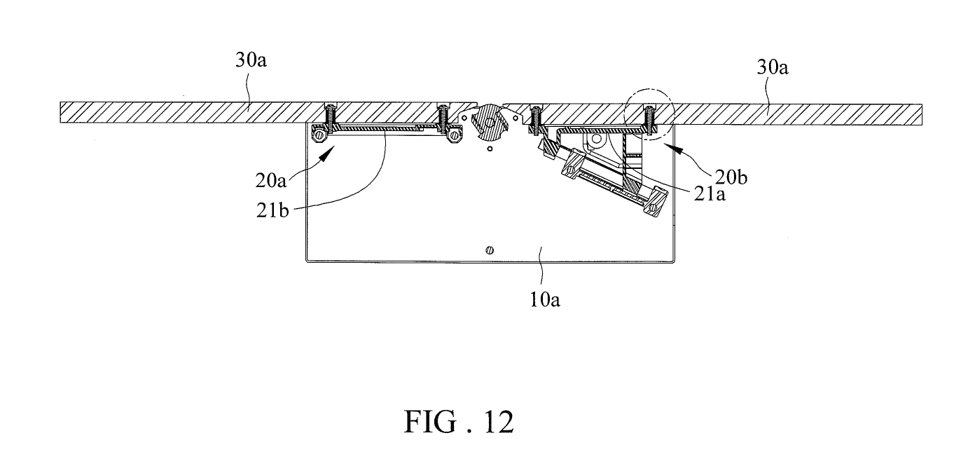

FIGS. 9 through 12 show a level adjusting device and worktables in accordance with a second embodiment of the present invention, wherein the same numerals are employed to denote the same parts previously shown and described. The second embodiment includes a base 10a, a first adjusting device 20a, a second adjusting device 20b, and two adjustable worktables 30a. The base 10a includes two separate panels disposed in a spaced relationship and opposite to each other, that is, a gap is defined between the two panels. The base 10a further includes at least one slide 11a mounted on the base 10a. In the preferred embodiment, the at least one slide 11a is mounted between the two panels of the base 10a and extends parallel to each panel. Further, a cutter-mounting body 12a is mounted on the base 10a. In the preferred embodiment, the cuter-mounting body 12a is mounted between the two panels of the base 10a. Likewise, the cutter-mounting body 12a receives a cutter that planes a workpiece. Additionally, the at least one slide 11a includes an adjusting mechanism 13a to be operated to move the first adjusting device 20a that is movably engaged with the slide 10a. One of the two adjustable worktables 30a is mounted on the first adjusting device 20a and is moved up and down upon moving the first adjusting device 20a with respect to the base 10a. The base 10a yet further includes at least one strut 14a mounted on the base 10a bearing the second adjusting device 20b. In the preferred embodiment, the base 10a includes two struts 14a, which are disposed in a spaced relationship, extending between the two panels of the base 10a.

Furthermore, the first adjusting device 20a includes a platform 21a, a plurality of adjustors 22a, a plurality of fastening members 23a and a plurality of spacers 24a. The platform 21a is made of cast iron for better shock absorption and includes at least one engaging section 211a, a bottom surface 212a, and a top surface 213a. The platform 21a is engaged with the at least one slide 11a, namely, the platform 21a includes two engaging sections 211a and the at least one slide 11a includes two slides 11a engaging with the two engaging sections 211a of the platform 21a, respectively. In the preferred embodiment, each slide 11a is in the form of a shaft and has a circular cross section and each engaging section 211a is in the form of an orifice and has a circular cross section, so the slide 11a is inserted through the engaging section 211a. The bottom surface 212a and the top surface 213a are parallel to each other. Additionally, the top surface 213a includes a plurality of stopping structures 214a extending therein. Further, a plurality of apertures 215a extend in the platform 21a and are defined coaxially and in communication with the plurality of the stopping structures 214a, respectively. Each aperture 215a has a threaded inner periphery. Each adjustor 22a includes a first section 221a, a second section 222a extending from the first section 221a, and a through hole 223a extending through the first and second sections 221a and 222a. Additionally, the second section 221a of each adjustor 22a includes a contacting end 224a defined thereon. Furthermore, the first section 221 and the contacting end 224a of each adjustor 22a are defined on two opposing ends thereof. Each fastening member 23a includes a first section 231a, and a second section 232a extending from the first section 231a, and in addition, the first section 231a includes a recess defined therein to be engaged with a tool that facilitates an adjustment of the fastening member 23a, and the second section 232a includes a threaded outer periphery.

In addition, the second adjusting device 20b includes a platform 21b, a plurality of adjustors 22b, a plurality of fastening members 23b, and a plurality of spacers 24b. The platform 21b is made of cast iron for better shock absorption and includes at least one engaging section 211b, a bottom surface 212b, and a top surface 213b. The platform 21b is engaged with the at least one strut 14a, namely, the platform 21b includes two engaging sections 211b and the two struts 14a as set forth engaging with the two engaging sections 211b of the platform 21b, respectively, so that the platform 21b is connected to the base 10a. The bottom surface 212b and the top surface 213b are parallel to each other. Additionally, the top surface 213a includes a plurality of stopping structures 214b extending therein. Further, a plurality of apertures 215a extend in the platform 21a and are defined coaxially and in communication with the plurality of the stopping structures 214a, respectively. Each aperture 215a has a threaded inner periphery. Each adjustor 22b is of the same structure as each adjustor 22a. Each fastening member 23b is of the structure as each fastening member 23a.

The adjustable worktables 30a are made of cast iron or aluminum. Each adjustable worktable 30a includes a plurality of receptacles 31a defined therein. Further, a plurality of retaining structures 32a are disposed in each adjustable worktable 30a, and each retaining structure 32a is in the form of an orifice extending in the adjustable worktable 30a and is disposed coaxially with one receptacle 31a.

The plurality of adjustors 22a are received in one adjustable worktable 30a and the plurality of adjustors 22b are received in the other adjustable worktable 30a, respectively, that is, the plurality of adjustors 22b are engaged in the plurality of retaining structures 32a of one adjustable worktables 30a and the plurality of adjustors 22b are engaged in the plurality of retaining structures 32a of the other adjustable worktable 30a, respectively. Each adjustor 22a and 22b has a threaded outer periphery. Each retaining structure 32a has a threaded inner periphery. In this regard, the outer threaded periphery of each adjustor 22a and 22b is engaged with the inner periphery of the retaining structure 32a engaged therein when the adjustor 22a and 22b is in thread engagement with the retaining structure 32a.

The plurality of fastening members 23a are inserted in one adjustable worktable 30a as well as the plurality of adjustors 22a and engage with the platform 21a and the plurality of fastening members 23b are inserted in the other adjustable worktable 30a as well as the plurality of adjustors 22b and engage with the platform 21b, respectively, that is, the plurality of fastening members 23a are inserted in the plurality of receptacles 31a of one adjustable worktable 30a and the through holes 223a of the plurality of adjustors 22a, respectively, with the first section 231a of each fastening member 23a received in the receptacle 31a, with the second section 232a of each fastening member 23a inserted through the through hole 223a and engaging in one aperture 215a. Preferably, the second section 232a of each fastening member 23a is not abutted against an inner periphery of the through hole 223a of each adjuster 22a.

The plurality of spacers 24a are retained on the plurality of stopping structures 214a, respectively. Furthermore, each spacer 24a is inserted through by one fastening member 23a.

The first adjusting device 20a is used to make the adjustable worktable 30a engaged therewith level with the other adjustable worktable 30a. In this regard, the adjustable worktable 30a is adjusted by adjusting the adjustors 22a with respect to the retaining structures 32a engaged therein, and the adjustable worktable 30a is moved by the adjustors 22a. Additionally, prior to adjusting each adjustor 22a, the fastening member 23a engaged therewith is removed and disengaged from the aperture 215a engaged therein with a tool that facilitates the removal thereof. After the fastening member 23a is removed, a tool for facilitating an adjustment of the adjustor 22a is engaged with the first section 221a and is operated to drive the adjustor 22a to urge the adjustable worktable 30 engaged therewith with respect to the platform 21a. Furthermore, each fastening member 23a that has been disengaged from the adjustor 22a and the platform 21a engaged therewith during a level adjustment of the adjustable worktable 30a engaged therewith is inserted through the adjustor 22a and engage with the platform 21a engaged therewith previously after the adjustment is finished. Likewise, the adjustable table 30a that the second adjusting device 20b engaged therewith is adapted to be adjusted with respect to the platform 21b through an adjustment of each adjustor 22b, and prior to adjusting the adjustor 22b, the fastening member 23b engaged therewith is removed.

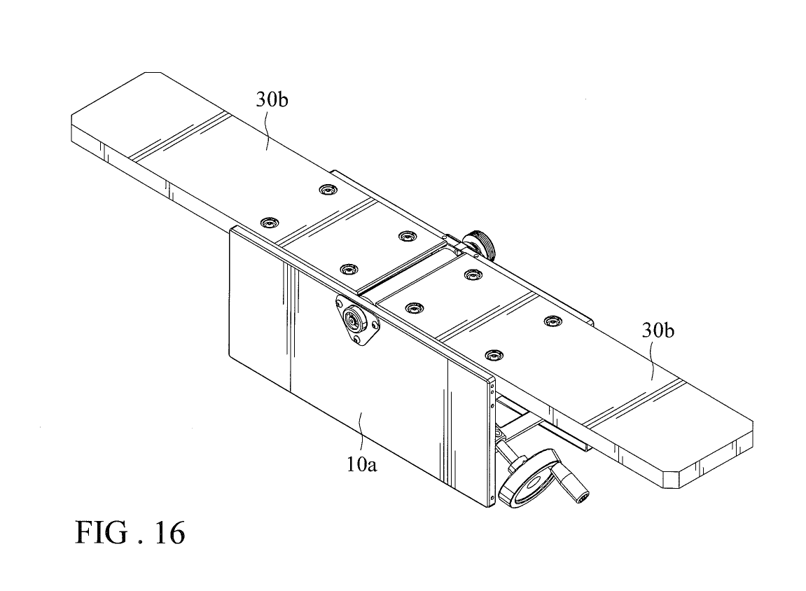

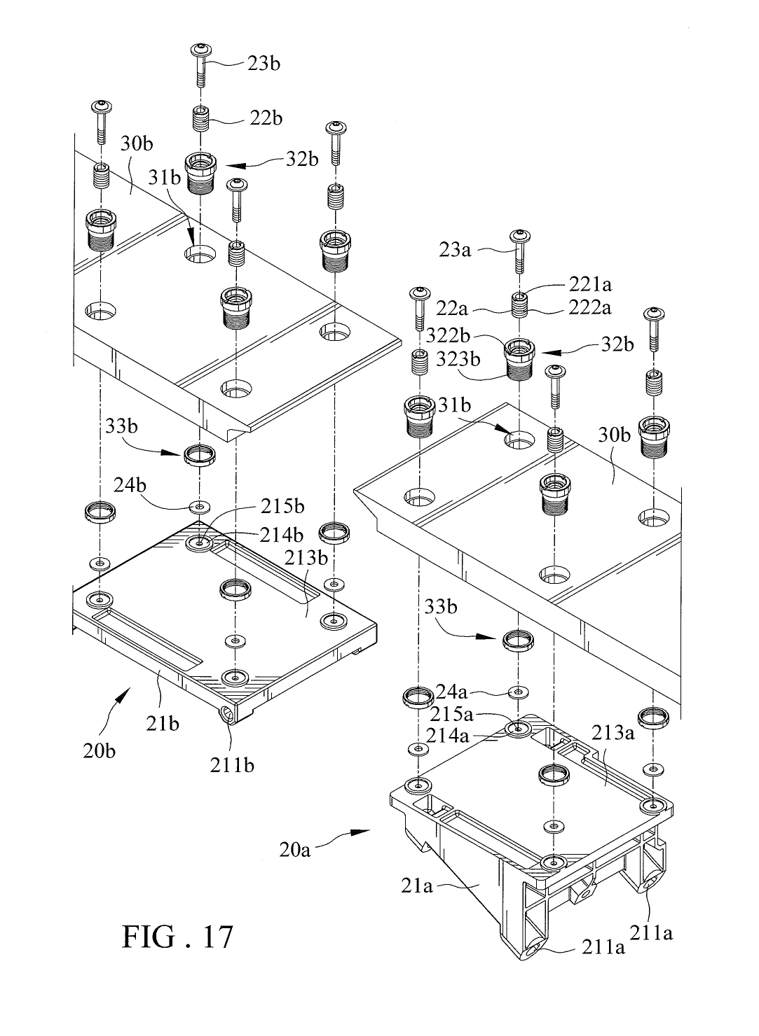

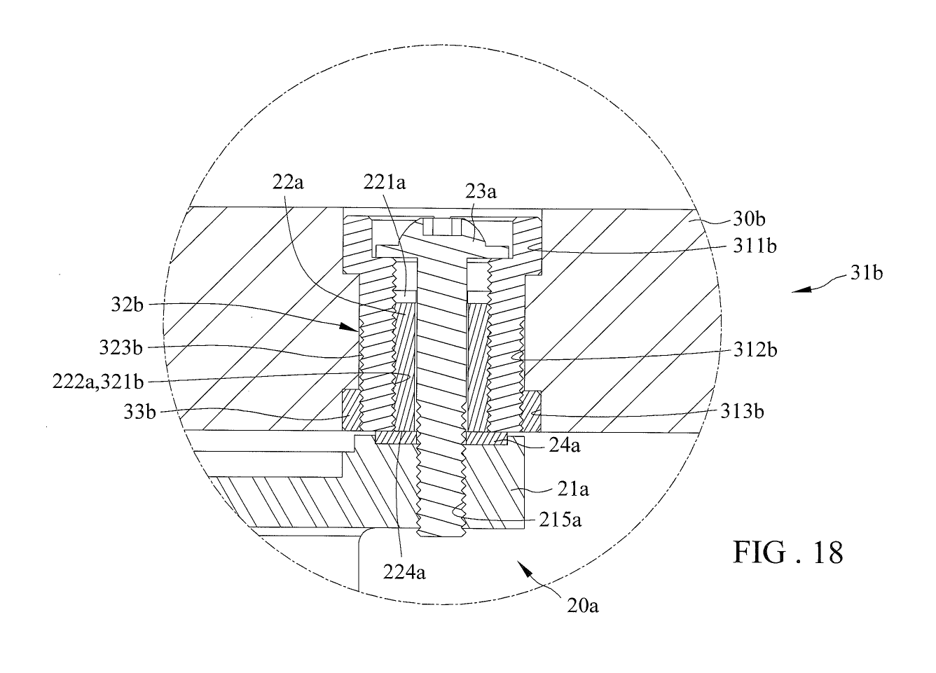

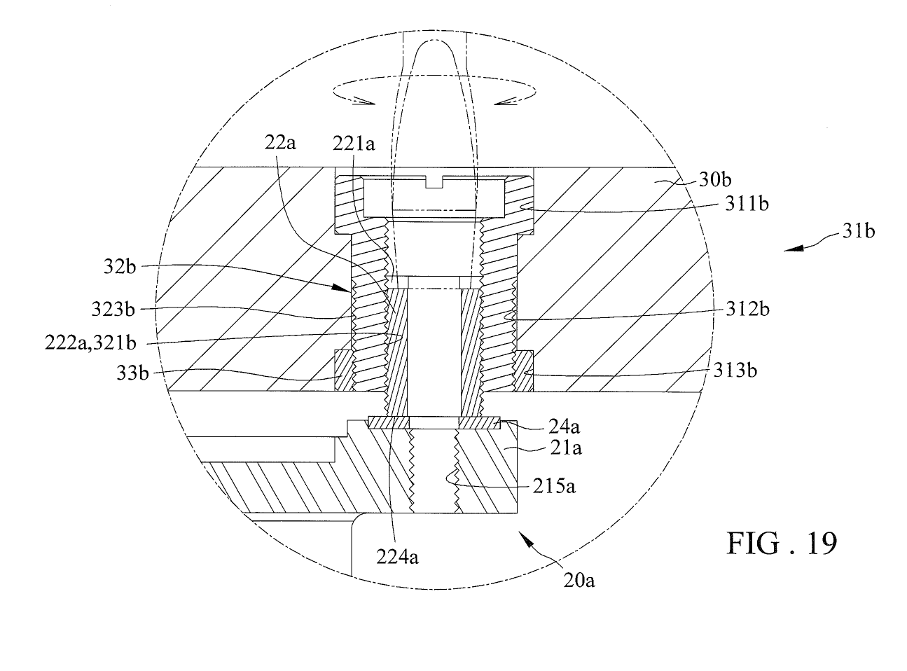

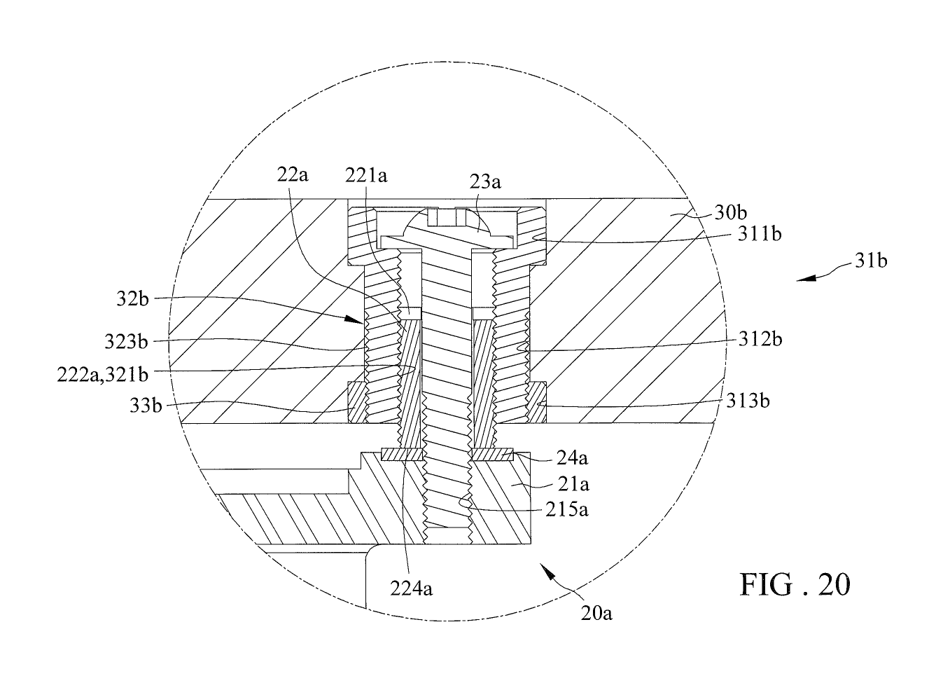

FIGS. 16 through 20 show a level adjusting device and worktables in accordance with a third embodiment of the present invention, wherein the same numerals are employed to denote the same parts previously shown and described, and wherein the third embodiment differentiate from the second embodiment in that the two adjustable worktables 30a are replaced with two adjustable worktables 30b. Each adjustable worktable 30b is made of granite and includes a plurality of receptacles 31b defined therein. Each receptacle 31b includes a smooth inner periphery and defines a first segment 311b, a second segment 312b, and a third segment 313b, and the second segment 312b is disposed between the first and third segments 311b and 313b and has a diameter smaller than diameters of the first and third segments 311b and 313b. Furthermore, each receptacle 31b includes a retaining structure 32b and an anti-disengagement structure 33b engaged therein, and the retaining structure 32b is engaged with the anti-disengagement structure 33b so as to be retained in the receptacle 31b and includes a hole 321b defined therein, a first section 322b to be engaged with a tool that facilitates an engagement of the retaining structure 32b with the anti-disengagement structure 33b, and a second section 323b extending from the first section 322b and engaging with the anti-disengagement structure 33b, and in addition, the anti-disengagement structure 33b is disposed in the third segment 313b of the receptacle 31b, and the first section 322b of the retaining structure 32b is received in the first segment 311b of the receptacle 31b, and the second section 323b of the retaining structure 32b is partly received in the second segment 312b and partly received in the third segment 313b of the receptacle 31b. The second section 323b of each retaining structure 32b has an outer periphery and the anti-engagement structure 33b engaged therewith has an inner periphery in thread engagement with the outer periphery of the retaining structure 32b. Also, each retaining structure 32b dose not extend out of the third segment 313b of the receptacle 31b engaged therein. In this regard, the first adjusting device 20a is engaged with one adjustable worktable 30b and is adjusted to level the engaged adjustable worktable 30b with the other adjustable worktable 30a, that is, the adjustable worktable 30b is adjusted by adjusting the adjustors 22a with respect to the retaining structures 32b engaged therewith, and the adjustable worktable 30a is moved by the adjustors 22a.

In view of the forgoing, the adjustable worktable 30, 30a, 30b that the adjusting device 20, 20a, and 30a engage therewith is adapted to be precisely fine-leveled with either the fixed worktable 50 or another adjustable worktables 30a and 30b connected therewith by the adjusting device 20, 20a, and 30a, and the adjusting device 20, 20a, and 30a is of a simple structure. Additionally, the adjustable worktables 30, 30b, and 50 are made of granite. Furthermore, the plurality of stopping structures 214, 41, 214a, and 214b can serve as reference points.

While the specific embodiments have been illustrated and described, numerous modifications come to mind without significantly departing from the spirit of invention and the scope of invention is only limited by the scope of accompanying claims.

What is claimed is:

1. A woodworking machine comprising:
a base;
an adjusting device engaged with the base and including a platform, a plurality of adjusters, and a plurality of fastening members, with the platform slidably engaged with the base, with the plurality of adjusters being adjustable, with the plurality of fastening members releasably inserted through the plurality of adjustors respectively; and
an adjustable worktable engaged with the adjusting device and including a plurality of receptacles defined therein and a plurality of retaining structures disposed therein;
wherein the platform bears the adjustable worktable and the plurality of adjusters abutted against the adjustable worktable; and
wherein the adjustable worktable is adjustably moved upon adjusting of the adjustors, and prior to adjusting each adjustor, the fastening member engaged therewith is removed.

2. The woodworking machine as claimed in claim 1, wherein the platform includes a plurality of apertures extending therein.

3. The woodworking machine as claimed in claim 2, wherein the platform of the adjusting device includes a plurality of stopping structures, with the plurality of stopping structures defined coaxially and in communication with the plurality of apertures respectively.

4. The woodworking machine as claimed in claim 1, wherein each adjuster includes a first section to be engaged with a tool for facilitating an adjustment of the adjuster, a second section extending from the first section, and a through hole receiving one fastening member, with the through hole extending through the first and second sections.

5. The woodworking machine as claimed in claim 2, wherein the plurality of adjustors are adjustably engaged in the plurality of apertures respectively.

6. The woodworking machine as claimed in claim 5, wherein the plurality of retaining structures are disposed in the plurality of receptacles respectively, and each retaining structure includes a hole defined therein, with the hole aligned with one aperture.

7. The woodworking machine as claimed in claim 6, wherein the plurality of adjuster are abutted against the plurality of retaining structures respectively, and the plurality of fastening members are engaged in the holes of the plurality of the retaining structures respectively.

8. The woodworking machine as claimed in claim 7, wherein the second section of each adjustor has an outer periphery engaged with an inner periphery of the aperture engaged therewith.

9. The woodworking machine as claimed in claim 8, wherein the second section of each adjustor is in thread engagement with the aperture engaged therewith.

10. The woodworking machine as claimed in claim 1, wherein each retaining structures is in the form of an orifice extending in the adjustable worktable and is disposed coaxially with one receptacle.

11. The woodworking machine as claimed in claim 10, wherein the plurality of fastening members are inserted in the plurality of receptacles of the adjustable worktable and the plurality of adjustors respectively, with the first section of each fastening member received in the receptacle, with the second section inserted through one of the adjustor and engaging in one of the plurality of apertures.

12. The woodworking machine as claimed in 11, wherein the second section of each fastening member is in thread engagement with the aperture engaged therein.

13. The woodworking machine as claimed in claim 1, wherein the adjustable worktable is made of granite.

14. The woodworking machine as claimed in claim 1 further comprising a fixed worktable the adjustable worktable is leveled with respect to.

15. The woodworking machine as claimed in claim 1, wherein the number of adjustable worktable is two, and the two adjustable tables are leveled with respect to each other.

16. The woodworking machine as claimed in claim 1, wherein the adjustable worktable is made of cast iron.

17. The woodworking machine as claimed in claim 1 further comprising a cutter-mounting body mounted on the base and receiving a cutter that planes a workpiece.
